(19) United States
(12) Patent Application Publication
(10) Pub. No.: US 2012/0248647 A1
(43) Pub. Date: Oct. 4, 2012

(54) METHOD FOR PRODUCING POLYETHYLENE TEREPHTHALATE

(75) Inventor: KUO-MIN WU, GUANYIN TOWNSHIP (TW)

(73) Assignee: KING-TILE CORP.

(21) Appl. No.: 13/432,127

(22) Filed: Mar. 28, 2012

(30) Foreign Application Priority Data
Apr. 1, 2011 (TW) 100111548

(51) Int. Cl. B28B 11/12

(52) U.S. Cl. 264/145

(57) ABSTRACT

A method for producing polyethylene terephthalate (PETG) includes the steps of mixing PETG particles and at least one additive raw material to form a mixed raw material; kneading the mixed raw material to form a gelatinized raw material; fluxing the gelatinized raw material; filtering the gelatinized raw material thus fluxed; secondarily fluxing the gelatinized raw material thus filtered to form a plastic dough; calendering the plastic dough to form a plastic fabric; embossing the plastic fabric; cooling the plastic fabric; and cutting the plastic fabric. Therefore, the aforesaid production method can produce PETG for use as an environmentally friendly material, in a manner that meets environmental protection needs, is suitable for the use in different locations, and reduces consumption of resources.

### CROSS-REFERENCE TO RELATED APPLICATION

This non-provisional application claims priority under 35 U.S.C. §119(a) on Patent Application No(s). 100111548 filed in Taiwan, R.O.C. on Apr. 1, 2011, the entire contents of which are hereby incorporated by reference.

### FIELD OF TECHNOLOGY

The present invention relates to methods for producing polyethylene terephthalate (PETG), and more particularly, to a method for producing polyethylene terephthalate (PETG) in a manner that meets environmental protection needs, is suitable for the use in different locations, and reduces consumption of resources.

### BACKGROUND

Hydrogen chloride (HCl) is produced as a result of the decomposition or combustion of recycled plastics which are made of polyvinylchloride (PVC), manufactured by a conventional calendering or extruding process and are in wide use. The hydrogen chloride thus produced contributes to acid rain and soil acidification. Furthermore, the plasticizer for use with PVC plastics is an endocrine disrupting chemical (EDC) that affects living organisms greatly and even puts some of them on the verge of extinction.

Hence, the question whether to forbid PVC plastics is brought up again in recent years. At present, the legal ban of using halogen-containing materials in a manufacturing process covers plenty of products. In this regard, construction materials (such as tiles) will become the next candidate for the prohibition, albeit gradually. The aforesaid issue also occurs to other types of plastics, such as Diethylhexylphthalate (DEHP) and Diisononylphthalate (DINP).

At present, PVC free plastics are made of polypropylene (PP) or polyethylene (PE), for example. The back-end processing process of polymers of these materials is intricate and thus fails to meet demand.

Therefore, it is imperative to invent a method for producing polyethylene terephthalate (PETG) in a manner that meets environmental protection needs, is suitable for the use in different locations, and reduces consumption of resources.

### SUMMARY

In order to improve the disadvantage of the traditional plastics, the inventor of the present invention considered it imperfect and thus conducted extensive researches and experiments according to the inventor's years of experience in the related industry, and finally developed a method for producing polyethylene terephthalate (PETG) in a manner that meets environmental protection needs, is suitable for the use in different locations, and reduces consumption of resources.

It is a primary objective of the present invention to provide a method for producing polyethylene terephthalate (PETG). The method produces PETG for use as an environmentally friendly material, in a manner that meets environmental protection needs, is suitable for the use in different locations, and reduces consumption of resources.

In order to achieve the above and other objectives, the present invention provides a method for producing polyethylene terephthalate (PETG). The method comprises the steps of:

mixing PETG particles and at least one additive raw material to form a mixed raw material;

kneading the mixed raw material to form a gelatinized raw material;

fluxing the gelatinized raw material;

filtering the gelatinized raw material thus fluxed;

secondarily fluxing the gelatinized raw material thus filtered to form a plastic dough;

calendering the plastic dough to form a plastic fabric;

embossing the plastic fabric;

cooling the plastic fabric; and

cutting or winding the plastic fabric.

Hence, the aforesaid production method can produce PETG for use as an environmentally friendly material, in a manner that meets environmental protection needs, applies to different environments, and reduces consumption of resources.

### BRIEF DESCRIPTION

Objectives, features, and advantages of the present invention are hereunder illustrated with specific embodiments in conjunction with the accompanying drawings, in which:

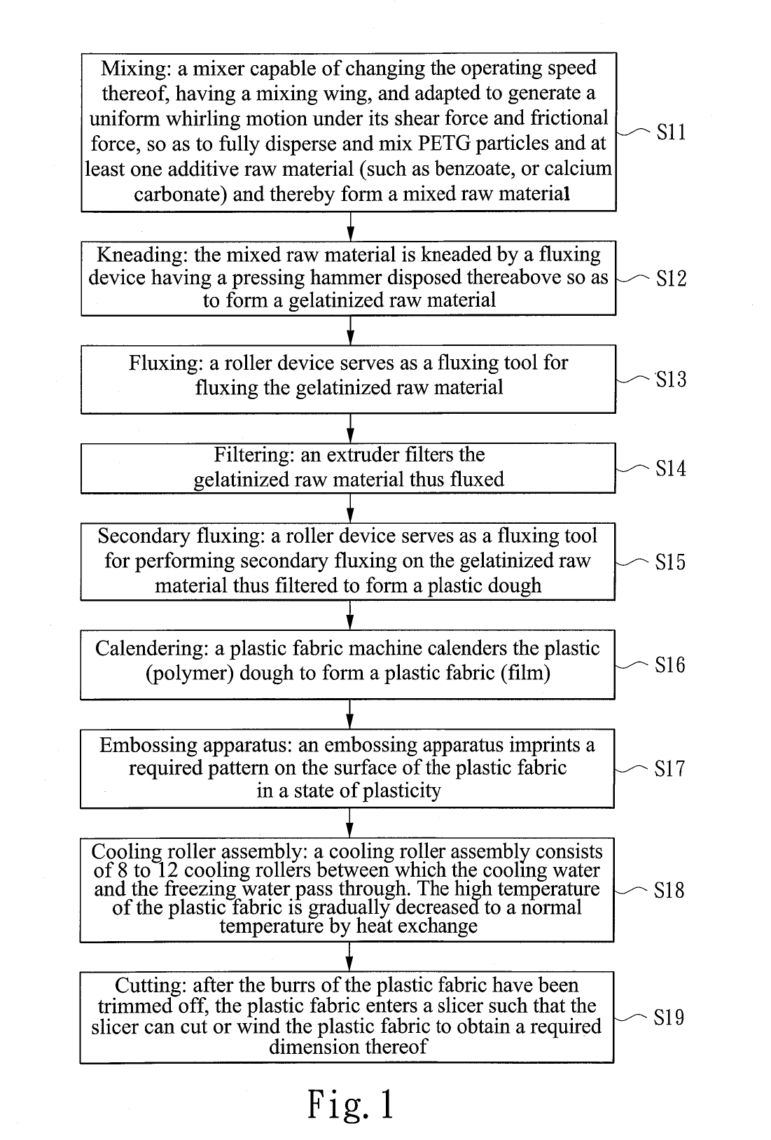

FIG. 1 is a flow chart of a method for producing polyethylene terephthalate (PETG) according to an embodiment of the present invention; and

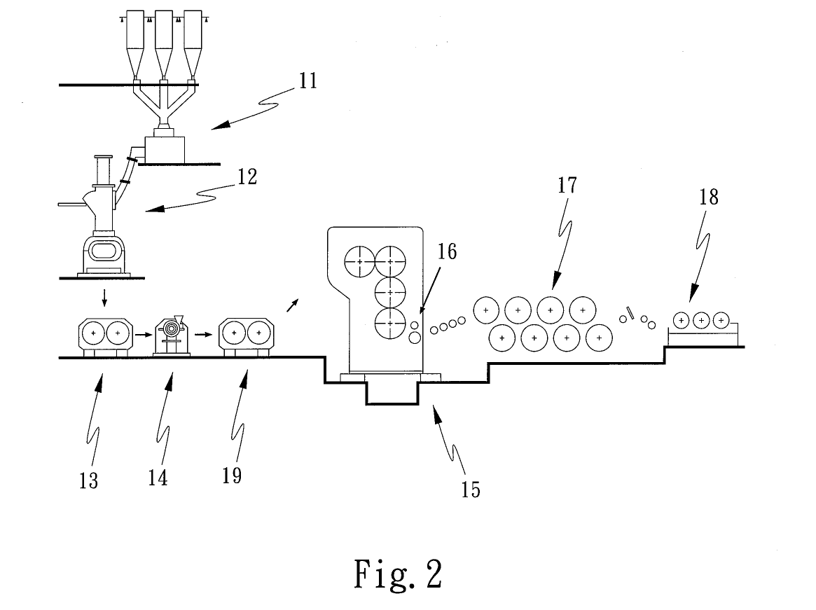

FIG. 2 is a schematic view of apparatuses for use with the method for producing PETG according to an embodiment of the present invention.

### DETAILED DESCRIPTION

Referring to FIG. 1 and FIG. 2, there is shown in FIG. 1 a flow chart of a method for producing polyethylene terephthalate (PETG) according to an embodiment of the present invention, and there is shown in FIG. 2 is a schematic view of apparatuses for use with the method for producing PETG according to an embodiment of the present invention.

As shown in the drawings, a method for producing PETG according to an embodiment of the present invention comprises the steps of:

1. Mixing: a mixer 11 capable of changing the operating speed thereof, having a mixing wing, and adapted to generate a uniform whirling motion under its shear force and frictional force, so as to fully disperse and mix PETG particles and at least one additive raw material (such as benzoate, or calcium carbonate) and thereby form a mixed raw material (step S11).

2. Kneading: the mixed raw material is kneaded by a fluxing device 12 having a pressing hammer disposed thereabove so as to form a gelatinized raw material (step S12). The chamber of the fluxing device 12 accommodates two rotors each having a hunched wing-like structure, and the two rotors rotate in a direction opposite to each other. The strong cutting operation is performed between an axle and the chamber wall and between a rotor and another rotor; hence, heat is generated for performing the fluxing process. The aforesaid kneading process is like kneading flour to form a flour dough. PETG molecules become soft when heated and under an applied force. A softening agent reacts with PETG molecules and fluxes with other materials to form viscous and elastic plastics.

3. Fluxing: a roller device 13 serves as a fluxing tool for fluxing the gelatinized raw material (step S13). The roller device 13 consists of two rollers capable of changing the operating speed thereof and being heated. The degree of gelatinization is enhanced by heating the raw materials continuously and performing crosscut manually and repeated. Furthermore, the mixed raw materials are cut by means of the difference in the speed between the two rollers. The front roller is heated up to a temperature slightly higher than the rear roller is, such that the raw materials can be conveyed in a specific direction.

4. Filtering: an extruder 14 filters the gelatinized raw material thus fluxed (step S14). A filtering wire gauze is installed at the outlet, which manifests three features as follows:

i. providing an appropriate temperature and feeding an evenly gelatinized material into a plastic fabric machine;
ii. fending off rigid bodies, such as stones or iron scraps, to protect the plastic fabric machine and prevent the rollers from being damaged; and
iii. maintaining a uniform and constant temperature of the plastic materials.

5. Secondary fluxing: a roller device 19 serves as a fluxing tool for performing secondary fluxing on the gelatinized raw material thus filtered to form a plastic dough (step S15).

6. Calendering: a plastic fabric machine 15 calenders the plastic (polymer) dough to form a plastic fabric (film) (step S16). The plastic dough enters the plastic fabric machine 15 by passing through a nip between the first roller and the second roller, such that the plastic dough is compressed to take on a sheet-like appearance. The sheet-like plastic dough winds around the second roller to enter a nip between the second roller and the third roller. After leaving the nip between the second roller and the third roller, the plastic dough winds around the third roller to enter a nip between the third roller and the fourth roller. Upon its entry into a nip between two rollers, the plastic dough always leaves behind a trace (known as a bank) thereof The bank rotates together with the rollers. The calendering can be completed only in the presence of the continuity of three banks.

7. Embossing apparatus: an embossing apparatus 16 imprints a required pattern on the surface of the plastic fabric in a state of plasticity (step S17). The axle has therein a water conveying duct, and the water temperature can be set as needed. The temperature is decreased while the embossing process is underway, such that an embossed pattern is fixed in place.

8. Cooling roller assembly: a cooling roller assembly 17 consists of 8 to 12 cooling rollers between which the cooling water and the freezing water pass through. The high temperature of the plastic fabric is gradually decreased to a normal temperature by heat exchange (step S18). The temperature of the cooling rollers is distributed in the manner that it decreases from the front roller to the rear roller. If the water flows from the front to the rear in the same direction as the plastic fabric does, the temperature will decrease gradually.

9. Cutting: after the burrs of the plastic fabric have been trimmed off, the plastic fabric enters a slicer 18 such that the slicer 18 can cut the plastic fabric to obtain a required dimension thereof (step S19). In addition to cutting, the slicer 18 performs winding and calculation of the total length of a resultant slice.

Hence, the aforesaid production method can produce PETG for use as an environmentally friendly material, in a manner that meets environmental protection needs, is suitable for the use in different locations, and reduces consumption of resources.

In other words, a PETG environmentally friendly material produced by the aforesaid production method has advantages as follows:

1. A PETG environmentally friendly material produced by the aforesaid production method is an environmentally friendly plastic product. For example, the aforesaid plastic product is made of raw materials which include PETG plastics (e.g., 15%˜50%), benzoates (e.g., 1%˜10%), filler raw materials (such as calcium carbonate, e.g., 50%˜76%), and a modifying agent, for altering the inherently high rigidity and high hardness of PETG such that the resultant PETG manifests flexibility at normal temperature.

2. A PETG environmentally friendly material produced by the aforesaid production method is not only free of the adverse effect otherwise demonstrated by conventional PVC plastics, but also reduces the pollution caused by an endocrine disrupting chemical (EDC) by dispensing with DEHP or DINP.

3. A PETG environmentally friendly material produced by the aforesaid production method can be recycled and reused and thus can reduce a waste of the resources of the earth.

4. Unlike a conventional plastic material, such as PP or PE, which features an intricate back-end polymer processing process, a PETG environmentally friendly material produced by the aforesaid production method can substitute for PVC materials to a nearly 100% extent in follow-up processing industry because PETG is highly compatible with PVC, without the hassle of purchasing additional special equipment and performing related treatment with the same.

5. A large amount of calcium carbonate is added to a PETG environmentally friendly material produced by the aforesaid production method so as to cut costs; hence, the PETG environmentally friendly material thus produced can replace PVC products in the manufacturing of plastic construction material (e.g., tiles), for example.

Hence, the present invention meets the three requirements of patentability, namely novelty, non-obviousness, and industrial applicability. Regarding novelty and non-obviousness, the present invention discloses a method for producing polyethylene terephthalate (PETG) for use as an environmentally friendly material, in a manner that meets environmental protection needs, applies to different environments, and reduces consumption of resources. Regarding industrial applicability, products derived from the present invention meet current market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method for producing polyethylene terephthalate (PETG), the method comprising the steps of:
mixing PETG particles and at least one additive raw material to form a mixed raw material;
kneading the mixed raw material to form a gelatinized raw material;
fluxing the gelatinized raw material;
filtering the gelatinized raw material thus fluxed;
secondarily fluxing the gelatinized raw material thus filtered to form a plastic dough;
calendering the plastic dough to form a plastic fabric;
embossing the plastic fabric;
cooling the plastic fabric; and
cutting the plastic fabric.

2. The method of claim 1, wherein the step of mixing PETG particles and at least one additive raw material is performed by a mixer.

3. The method of claim 1, wherein the additive raw material is a calcium carbonate.

4. The method of claim 1, wherein the step of kneading the mixed raw material is performed by a fluxing device.

5. The method of claim 1, wherein the step of fluxing the gelatinized raw material is performed by a roller device.

6. The method of claim 1, wherein an extruder filters the gelatinized raw material thus fluxed.

7. The method of claim 1, wherein a plastic fabric machine calenders the plastic dough.

8. The method of claim 1, wherein an embossing apparatus embosses the plastic fabric.

9. The method of claim 1, wherein a cooling roller assembly cools the plastic fabric.

10. The method of claim 1, wherein a slicer cuts or winds the plastic fabric.
